(19) United States
(12) Patent Application Publication
(10) Pub. No.: US 2025/0137668 A1
(43) Pub. Date: May 1, 2025

(54) Room Air Conditioner with a Thermoelectric Heat Pump

(71) Applicant: Siemens Schweiz AG, Zürich (CH)

(72) Inventors: Michael Kiy, Hünenberg (CH); Christoph Kiener, München (DE); Diego Alejandro Montalvo Beltran, Berlin (DE)

(73) Assignee: Siemens Schweiz AG, Zürich (CH)

(21) Appl. No.: 18/923,987

(22) Filed: Oct. 23, 2024

(30) Foreign Application Priority Data
Oct. 25, 2023 (EP) 23205941.0
Dec. 7, 2023 (EP) 23214891.6

(51) Int. Cl. F24F 5/00

(52) U.S. Cl. CPC F24F 5/0042

(57) ABSTRACT

An example AC unit includes: a thermoelectric heat pump including an output plate and an input plate; an indoor heat exchanger thermally connected to the output plate to exchange heat with indoor air; an outdoor heat exchanger configured to exchange heat with an outdoor environment; a sensor for a cooling or a heating demand; and a controller to set a performance of the thermoelectric heat pump. Straight passages through the indoor heat exchanger in line with the main air flow towards them in operation contribute less than 44% to the frontal area of the region. The corresponding part of the indoor heat exchanger extends to a thermal connection to the output plate. The frontal area of the region is at least half the frontal area of the indoor heat exchanger. At least some air flow paths through the indoor heat exchanger do not include such a straight passage.

### CROSS-REFERENCE TO RELATED APPLICATIONS

This application claims priority to EP Application Serial No. 23214891.6 filed Dec. 7, 2023 and EP Application Serial No. 23205941.0 filed Oct. 23, 2023, the contents of which are hereby incorporated by reference in their entirety.

### TECHNICAL FIELD

The present disclosure relates to air conditioners. Various embodiments of the teachings herein include air conditioners with a thermoelectric heat pump and a thermally connected heat exchanger.

### BACKGROUND

WO2018/077321 describes structures for influencing the temperature of a solid object, for example a vehicle battery, a fluid container or a microprocessor. Some structures comprise a thermoelectric heat pump that is thermally connected to the solid object at one of e two contact plates of the thermoelectric heat pump, which plate therefore outputs heat or chill. On its opposite side, at the input plate, the thermoelectric heat pump is thermally connected to a heat exchanger with air flow paths therethrough. The heat exchanger disperses waste chill or waste heat in the surrounding air, based on the needs of the object, not on the needs of, say, room air conditioning. If closed loop control would be added, a sensor would sense the object temperature and not a measurand for a room air cooling demand or a room air heating demand, such as room air temperature, outside temperature, daylighting, dew point, volatile organic components or occupancy.

WO2018/077321 shows a thermoelectric heat pump and a porous heat exchanger with straight passages in various directions therethrough on top. The straight passages cover more than half of the respective frontal area. It is uncertain from where one would expect air to flow towards the heat exchanger in operation as intended, which depends on the shape and temperature of the solid object and other objects nearby, on the orientation of the structure and on the presence of a fan.

WO2018/077321 shows a cooling pipe above a heat exchanger on top of a thermoelectric heat pump. If one assumes this orientation of the structure and given that the structure only makes sense for cooling the thermally connected object, the cooling pipe slows down or even sends down rising hot air within the heat exchanger, making the air flow towards the heat exchanger chaotic, slow and instable. A heat exchanger that by design is not regularly exposed to a main air flow in operation as intended, is not configured to exchange heat.

WO2018/077321 shows irregularly printed heat exchangers that do without a thermoelectric heat pump. Their chaotic air flow paths appear to include large straight passages, but a frontal area estimation is impossible for lack of detail and a distinguishable background. Anyhow, the main air flow, if any, may not be aligned with the angle of view.

### SUMMARY

The teachings of the present disclosure include a room air conditioner comprising at least one thermoelectric heat pump that comprises an output plate and an input plate, as well as at least one indoor heat exchanger that is thermally connected to the output plate and that is configured in operation as intended to exchange heat with indoor air. For example, some embodiments include a room air conditioner, comprising: at least one thermoelectric heat pump (10) that comprises an output plate (11) and an input plate (12), at least one indoor heat exchanger (3) with air flow paths (20) therethrough that is thermally connected to the output plate (11) and that is configured in operation as intended to exchange heat with indoor air, at least one outdoor heat exchanger (8) that is thermally connected to the input plate (12) and that is configured in operation as intended to exchange heat with an outdoor environment, characterised in that the room air conditioner comprises at least one sensor (6, 9, 15) that is configured to sense a measurand for a cooling or a heating demand, the room air conditioner comprises a controller (16, 17) that is configured to generate output based on the sensor output and based on at least one setpoint and that is configured to set the performance of the thermoelectric heat pump (10) in accordance with its output, in a simply connected region on the indoor heat exchanger (3), straight passages (18, 21) through the indoor heat exchanger (3) in line with the main air flow towards them in operation as intended are absent or contribute less than 44% to the frontal area of the region, the corresponding part of the indoor heat exchanger (3) extends to where it is thermally connected to the output plate (11), the frontal area of the region is at least half the frontal area of the indoor heat exchanger (3), and at least some air flow paths (20) through the indoor heat exchanger (3) do not include such a straight passage (18, 21).

In some embodiments, such straight passages (18, 21) are absent or contribute less than 36% to the frontal area of the region.

In some embodiments, along most air flow paths through the indoor heat exchanger (3) the path wall (19) by protruding or receding transversally changes the air flow path cross sectional area locally by more than 2% of the previous air flow path cross sectional area at least 20 times.

In some embodiments, the surface of the indoor heat exchanger (3) is uneven over at least 40% of its area.

In some embodiments, in operation as intended the cross-sectional area of the indoor heat exchanger (3) in line with the main air flow towards its leading edges that are at a shared distance to where it is thermally connected to the output plate (11), gradually decreases with greater distance.

In some embodiments, the shape of the indoor heat exchanger (3) tapers away from where it is thermally connected to the output plate (11) of the thermoelectric heat pump (10).

In some embodiments, the indoor heat exchanger (3) comprises a heat isolating surface cover at least adjacent to where it is thermally connected to the output plate (11) of the thermoelectric heat pump (10).

In some embodiments, the room air conditioner comprises at least one indoor heat exchanger holder (4, 5) that is configured reversibly to hold the indoor heat exchanger (3).

In some embodiments, the sensor (6, 9, 15) or the controller (16, 17) includes a module (14) in the main body of the room air conditioner (1) that is configured to receive data from a remote part of it and to act in accordance therewith.

In some embodiments, the controller (16, 17) is configured at times to amend its output for restricting the temperature difference between the output plate (11) and the input plate (12) of the thermoelectric heat pump (10).

In some embodiments, the amendment is meant to restrict the difference to a maximum that is below 35° C.

In some embodiments, the controller (16, 17) is configured at times to amend its output for restricting condensation at the output plate (11) of the thermoelectric heat pump (10) or on the indoor heat exchanger (3).

In some embodiments, the controller (16, 17) is configured to calculate the performance of the thermoelectric heat pump (10) at which condensation would occur.

In some embodiments, the controller (16, 17) is configured at times not to make the thermoelectric heat pump (10) cool the output plate (11) even though the sensor output and the setpoint would require doing so.

In some embodiments, the controller (16, 17) is configured at times to amend its output for heating the output plate (11) temporarily above a minimum that is above 60° C.

### BRIEF DESCRIPTION OF THE DRAWINGS

The teachings of the present disclosure are illustrated in the drawings as follows.

FIG. 1 shows a sketch of the main body of an example room air conditioner incorporating teachings of the present disclosure;

FIG. 2 shows a schema in sideways view of components in a part of the main body of the same room air conditioner;

FIG. 3 shows a sketch of a rectangular cut-out of the indoor heat exchanger of an example room air conditioner incorporating teachings of the present disclosure;

FIG. 4 shows a sketch of a rectangular cut-out of a variant indoor heat exchanger for a similar room air conditioner incorporating teachings of the present disclosure to where it is thermally connected; and

FIG. 5 shows a sketch of a rectangular cut-out of the same variant indoor heat exchanger far from where it is thermally connected.

### DETAILED DESCRIPTION

Suitable thermoelectric heat pumps of various design can be obtained commercially. Examples of their construction are described in US2005/0016575A1 for instance. Such room air controllers are described in US2013/0319014A1. Every indoor heat exchanger consists of fins on the output plates of the thermoelectric heat pumps. The fins are specified as pieces of sheet metal, ribs, fingers, et cetera. They are shown in the figures to be freestanding within an air channel, therefore not constituting walls around paths for the air to flow through the indoor heat exchanger. In particular, air flow paths at an angle to the main air flow towards the indoor heat exchanger in operation as intended are absent.

An indoor heat exchanger of the room air conditioner incorporating teachings of the present disclosure features air flow paths therethrough.

A room air conditioner with a thermoelectric heat pump that pumps heat between the flat plates on either side is described in US2017/0363307A1. In operation as intended, a centrally mounted fan pulls air from the room and pushes it out radially towards an indoor heat exchanger. The latter consists of flat metal plates that are arranged side-by-side in a semi-circle around the fan, at their sides in contact with the housing of the room air conditioner, as well as perpendicular thermosiphons that hold the metal plates together and that also provide the thermal connection to the output plate of the thermoelectric heat pump.

Between the metal plates and the thermosiphons, straight passages are lined up with the main air flow towards them. They account for more than half of the frontal area of the indoor heat exchanger, which indicates low air flow resistance. Along the flow path of the air therethrough, each curved thermosiphon first protrudes and then recedes transversally, changing the air flow path cross sectional area locally. The thermosiphons between a neighbouring pair of metal plates in line with that main air flow also constitute air flow path walls of an interconnected side channel. The air leaves the indoor heat exchanger downwards back into the room, therefore as indoor air, for cooling the lower part thereof. Other air from the room is forced upwards through a second heat exchanger that is connected thermally to the other plate of the thermoelectric heat pump, thus heating the higher part of the room.

A room air conditioner incorporating teachings of the present disclosure also comprises at least one outdoor heat exchanger that is thermally connected to the input plate of the thermoelectric heat pump and that is configured in operation as intended to exchange heat with an outdoor environment.

Such a room air conditioner is indicated in patent application KR2012035308A. By means of an indoor heat exchanger that extends into an entry air channel, a thermoelectric heat pump can remove heat from or add heat to air from outside. A motorised fan draws the fresh indoor air into the room. The indoor heat exchanger is said to be a heat sink block and appears to be a structure of aligned metal plates that form straight passages in line with the main air flow towards them. Their dominant frontal straight passage area and the smooth plate surfaces without transversal protrusions or recessions suggest that they surround air flow paths of highly laminar air flow with minimal air resistance. A similar outdoor heat exchanger on the other side of the thermoelectric heat pump is located indoors but extends into an exit air channel, through which air from the room is blown outdoors, thus disposing of heat in air on its way to an outdoor environment, respectively collecting heat therefrom.

For application in buildings, ships, cars, and the like, with requirements such as reliably avoiding condensation, thermoelectric cooling is known to be less efficient and less effective and more expensive than cooling with vapor-compression refrigeration. Thermoelectric heating suffers from similar disadvantages. This has prevented their broad use despite some obvious advantages, such as decentral installation, retrofit installation, compactness and low maintenance. The object of the invention is to provide room air conditioners with thermoelectric cooling or heating that better suit the application.

In some embodiments of the teachings herein, in a simply connected region on the indoor heat exchanger, straight passages through the indoor heat exchanger in line with the main air flow towards them in operation as intended are absent or contribute less than 44% to the frontal area of the region, the corresponding part of the indoor heat exchanger extends to where it is thermally connected to the output plate, and the frontal area of the region is at least half the frontal area of the indoor heat exchanger. In some embodiments, with a good choice of structure and material for the indoor heat exchanger, such straight passages in the region are absent or contribute less than 36% to the frontal area of the region.

In operation, air does flow towards a heat exchanger predominantly in main directions before it may be diverted on a local scale by flowing around the leading edges of the indoor heat exchanger material itself. If the room air conditioner comprises a motorised ventilator, the effect of an initial rotational component of the airspeed often can be neglected, or else sufficiently well estimated. The same holds true for the effect of standing sound waves inside an air channel. In some embodiments, without a ventilator or slanted walls nearby, the main air flow direction towards the indoor heat exchanger is along the vertical, because the air density changes when the air is cooled or heated therein. An occasional interference by other air flow in the room may lead to a temporary reduction of effect or of efficiency but can be ignored for the purpose of the invention.

Disturbing the air flow on entry into or within the indoor heat exchanger of a room air conditioner by reducing the frontal area of the straight passages therethrough disproportionately improves the exchange of heat therewith, generally improving the conductivity of heat within the indoor heat exchanger too, while the air flow through the indoor heat exchanger can be kept at acceptable levels. This allows meeting the commercial requirements for broader application of the room air conditioner, including practical upper limits on production costs and size. Instead of the whole indoor heat exchanger, a simply connected region thereon suffices, if large enough and if the corresponding part of the indoor heat exchanger, that is its part behind the region in the main direction of the incoming air flow, extends to where it is thermally connected to the output plate of the thermoelectric heat pump. One could put indoor heat exchanger parts with wider or more densely placed straight passages in line with the incoming air flow next to the region, provided that they do not hinder the heat being conducted within the heat exchanger to where is thermally connected to the output plate, for example at an edge of the indoor heat exchanger. These extra indoor heat exchanger parts may raise the average frontal area contribution by straight air flow passages substantially, the major restriction being the size of the room air conditioner, while the indoor heat exchanger in the aforesaid region still brings benefits of the invention.

In some embodiments, there are air flow paths through the indoor heat exchanger that do not include such a straight passage. In some embodiments, the other air flow paths run through the corresponding part of the indoor heat exchanger.

Along most air flow paths through the indoor heat exchanger, e.g. through the corresponding part of the indoor heat exchanger, the path wall changes the air flow path cross sectional area locally by more than 2% of the previous air flow path cross sectional area at least 20 times by protruding or receding transversally, e.g. at least somewhere protruding or receding by at least 80 micrometres. Openings for air in between protruding path walls have a typical diameter of 4 mm at most. The surface of the indoor heat exchanger, or of the corresponding part thereof, is uneven over at least 40% of its area. An uneven surface is not flat but curved or, down to the scale of at least 80 micrometres, rough, or something in between. The air flow resistance is hardly affected thereby.

In operation as intended the cross-sectional area of the indoor heat exchanger in line with the main air flow towards its leading edges that are at a shared distance to where the indoor heat exchanger is thermally connected to the output plate of the thermoelectric heat pump, gradually decreases with greater distance, e.g. such that the inner temperature gradient size is similar everywhere to within half its average value in dynamic equilibrium. Leading edges of the indoor heat exchanger are at a shared distance if each has the same minimal distance to every point where the indoor heat exchanger is thermally connected to the output plate. Some fluctuation of the cross-sectional area may occur, for instance when in a periodic indoor heat exchanger structure an almost parallel elongate part is quickly intersected. Even so, the inner temperature gradient of the indoor heat exchanger can be made low and stable in operation as intended. The indoor heat exchanger therefore can have a larger size without unacceptable loss of effectivity at its far end or condensation where it touches the output plate or loss of efficiency from creating too large a temperature difference between the thermoelectric heat pump plates.

In some embodiments, the ratio of the average cross-sectional area of the indoor heat exchanger to the average cross-sectional area in between its material decreases if the distance increases from where the indoor heat exchanger is thermally connected to the output plate. This can be achieved by giving the indoor heat exchanger fewer material parts per unit volume or by giving it thinner material parts per unit volume. The shape of the indoor heat exchanger tapers away from where it is thermally connected to the output plate of the thermoelectric heat pump. Then the envelope of such cross sections closes in on itself with increasing distance, which has a similar effect even if the content of the indoor heat exchanger is homogenous. In some embodiments, its shape tapers away essentially horizontally in operation as intended. The flat thermoelectric heat pump is best positioned parallel to the outer wall of the room in which the room air conditioner is installed, and the indoor heat exchanger is held directly against it. Then, the indoor heat exchanger from the side resembles for instance a pointed capital letter “L”. If the output plate of the thermoelectric heat pump in operation extends horizontally, the indoor heat exchanger might resemble a discus that overhangs the thermoelectric heat pump.

Techniques in powder metallurgy and additive manufacturing allow accurate and cost-effective production of such indoor heat exchangers. They may contain of a metal or an alloy, preferably an alloy with a high content of aluminium. They may be shaped as a network of interconnected strips, say, a tree network or a mesh network such as a porous metal foam, or rather as a folded sheet structure, in particular with a near minimal surface. They may be quasi-chaotic or periodical. They can be made sufficiently hollow for the air to flow through. They can be made appropriately shaped for the heat to be exchanged with the air. They can be made sufficiently solid for the heat to be conducted therein. Less accurate techniques can be used too for producing the indoor heat exchangers for a room air conditioner according to the invention, such as sintering pre-shaped pieces of a thermally conductive ceramic, most likely aluminium nitride composites, or pieces of an alloy.

The indoor heat exchanger comprises a heat isolating surface cover at least adjacent to where it is thermally connected to the output plate of the thermoelectric heat pump. In some embodiments, any heat conduit between the indoor heat exchanger and the output plate of the thermoelectric heat pump comprises the cover too, as well as the output plate itself where it is not in contact with either. The heat isolating surface cover might contain one or several polymer materials.

The room air conditioner comprises at least one indoor heat exchanger holder that is configured reversibly to hold the indoor heat exchanger, e.g. against the output plate of the thermoelectric heat pump. An indoor heat exchanger holder might be a clamp made of wires that encompass s the indoor heat exchanger, or else one of several flange button head screws and material having threaded holes with which it can interact. These measures allow easy removal of the indoor heat exchanger for cleaning or replacement. In some embodiments, the room air conditioner also comprises an actuator that is configured to move the indoor heat exchanger holder, so as to increase the exchange of heat with the indoor air. In some embodiments, the room air conditioner is configured to expose air from within the room to the indoor heat exchanger, rather than for instance enclosing the indoor heat exchanger in an entry air channel and in operation drawing only air from outside indoors.

Thermally connected at the other side of the thermoelectric heat pump, the outdoor heat exchanger typically can be made larger than the indoor heat exchanger. Typically, it can be put out of sight, if appropriate by connecting it to the input plate via a heat conduit, e.g. a passive heat conduit such as a thermosiphon or heat pipe. Outdoors it can be ventilated with less consideration of noise. Still, especially if the outdoor heat exchanger is configured to transfer heat to or from air, it may comprise a structure as described herein for indoor heat exchangers. In some embodiments, it may be a liquid flow channel in close contact with or even complemented by at least a part of the input plate. While such an outdoor heat exchanger may be located indoors, the flow disposes of heat or chill in an outdoor environment. For instance, a metal box against the input plate, e.g. with heat conducting paste in between, comprises a connector for a pipe that fills it with cold water and a connector for a pipe that leads the heated water to a drain outdoors.

The aforesaid structural measures deal with the problem of comparatively small room air conditioners with thermoelectric heat pumps, yielding an increase in performance and economy while still minimising condensation while cooling, odour while heating and unsuitable maintenance efforts.

The room air conditioner comprises at least one sensor that is configured to sense a measurand for the cooling demand, as well as a controller that is configured to generate output based on the sensor output and based on at least one setpoint, and that is configured to set the performance of the thermoelectric heat pump in accordance with its output.

Examples of a measurand are a change of passive infrared radiation by human movement in the room, the lighting level in a windowless room or something else that indicates occupancy. In some embodiments, a measurand indicates air temperature, for instance by means of a temperature sensitive resistor, an electromagnetic radiation sensitive semiconductor junction or an acoustic wave sensitive piezoelectric substrate. Heating or cooling is often triggered by a sensor of the air temperature outside the building. In some embodiments, a measurand indicates the temperature of air inside the room. Ideally, the room air conditioner also comprises a sensor of inside air humidity, say, a dew point sensor. Air humidity by itself is not a measurand for a cooling or heating demand, but it is if combined with the room air temperature.

The sensor and the controller might be integrated into the main body of the room air conditioner, but a part of either might be remote. If so, that sensor or controller includes a module in the main body of the room air conditioner that is configured to receive data and to act in accordance therewith. For example, a control software runs on a dedicated server or on a cloud server.

Then, the controller includes a module in the main body of the room air conditioner that is configured to receive control data and accordingly to set the performance of the thermoelectric heat pump. Also, the controller might perform a short-term control locally and a remote analysis for optimising the short-term control, to deduct especially whether relevant circumstances of operation have changed or to adapt control if it knows that they have. In some embodiments, the controller is configured to determine a need or to receive a request for user feedback and is configured to enquire feedback from a user. In some embodiments, it is configured to register an electronic device of the user and is configured to enquire feedback by means of the device, for instance by presenting a questionnaire or by using a large language model.

The controller sets the performance of the thermoelectric heat pump for instance by determining its electrical power intake. It might closed-loop-regulate the thermoelectric heat pump in any way, for instance in the two-point way by switching the thermoelectric heat pump on and off, or for instance: in continuous or near-continuous modulation in response to the proportional, the integral or the derivative of the difference between a processed sensor output and the setpoint. The controller is configured at times to amend its output as compared to mere regulation for restricting the temperature difference between the output plate and the input plate of the thermoelectric heat pump, in particular with the intention to restrict the difference to a maximum that is below 35° C., for staying in the most efficient performance range of the thermoelectric heat pump.

Likewise, the controller is configured at times to amend its output as compared to mere regulation for restricting condensation at the output plate of the thermoelectric heat pump or condensation on the indoor heat exchanger. It is configured to calculate the performance of the thermoelectric heat pump at which condensation occurs. This calculation might require an extra humidity sensor or dew point sensor, the frequent reception of weather data or an initial thermodynamic modelling specific to the room. In this way, the indoor heat exchanger can approach the dew point temperature closely without unacceptably crossing it. The controller in particular is configured at times not to make the thermoelectric heat pump cool the output plate even though the sensor output and the setpoint would require doing so. The controller even is configured at times to amend its output for heating the output plate temporarily above a minimum that is above 60° C. For the sake of disinfection of the indoor heat exchanger, the output plate average temperature preferably is held above 70° C. for some time, say, for 30s, thus keeping maintenance rare.

These control measures for a thermoelectric room air conditioner with an indoor heat exchanger that has few or no straight passages therethrough in line with the main incoming air flow require some calculation effort but allow optimisation of performance and economy or reduction of maintenance, while still preventing condensation and odour.

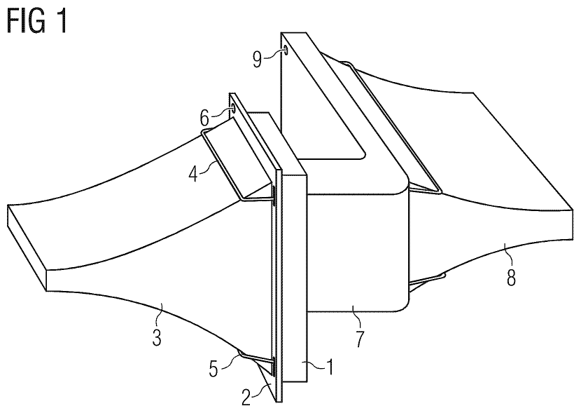

In FIG. 1, the main body of an example air conditioner for a room for human occupation contains a housing 1. It is meant to be mounted into an opening in the panelling to the left of a room window or into an opening of an air disposal duct or into an opening in an outer wall, for the main purpose of cooling at best high up in the room. An upright cover plate 2 measuring 22 cm by 22 cm should seal off the opening.

The indoor heat exchanger 3, which lacks structural detail here, is intended to be placed inside the room. No fixed objects obstruct the free flow of air in the room towards or away from it. It is held against the flat output plates of thermoelectric heat pumps that are mounted flush within a large gap in cover plate 2, none of which are shown here. In some embodiments, a thermal paste surrounds the material of the indoor heat exchanger 3 where it touches the output plates of the thermoelectric heat pumps. The clamps that hold the indoor heat exchanger 3 consist of thin rods 4, 5 and spring-loaded hinges for them, which are hidden within housing 1.

The indoor heat exchanger 3 on one side borders the output plates and on the other side tapers horizontally away from them. In operation, the beak-like protrusion can capture a larger vertical flow of air, as large as is practical thanks to an optimisation of its shape. For esthetical reasons and assuming some free space on either side of the room air conditioner main body, the horizontal tapered beak of the indoor heat exchanger alternatively could be rounded around the vertical such that it resembles a semi-circle disk.

When the room air conditioner cools the air that approaches from above, the leading edges of the indoor heat exchanger 3 on top that share a distance to the output plates of the thermoelectric heat pumps, build an almost straight surface line in parallel to rod 4. The area of the vertical cross-section along this line decreases with every increase of their shared distance away from the output plates. The decrease is chosen just so that in dynamic equilibrium, given the content of the indoor heat exchanger 3, the size in operation of the inner temperature gradient over the width of the indoor heat exchanger 3 is small, assuming that the approaching air has a homogenous temperature. A small linear change of the temperature everywhere within the indoor heat exchanger 3 allows its large horizontal extension without an unacceptable loss of efficiency by overexerting the thermoelectric heat pumps, or an unacceptable condensation where their output plates touch the indoor heat exchanger 3 or an unacceptable loss of effectivity at the far end of the taper.

A sensor suite 6 inside and behind cover plate 2 senses both temperature and humidity locally, close to the cooling plate of the thermoelectric heat pump yet upstream during a cooling operation. Thus, the place is well suited for dew point measurements and very well suited for indoor air temperature measurements during cooling. Sensor suite 6 also comprises a temperature sensor that can measure a temperature at a distance as an indication of the general air temperature in the room.

Meant to be placed outside the room, the outdoor heat exchanger is thermally connected to the input plate at the backside of the thermoelectric heat pump by heat pipes within an arm 7. The outdoor heat exchanger 8 is larger than the indoor heat exchanger 3. It is positioned away from any window next to which the room air conditioner main body has been installed, further to the left thereof, so as less to obstruct the view from inside the room.

At the back of heat pipes arm 7, on the shady side thereof and away from the heated air stream that rises from the outdoor heat exchanger 8 if the room air conditioner is cooling the room, an air temperature sensor 9 is mounted for measuring the air temperature outside the room.

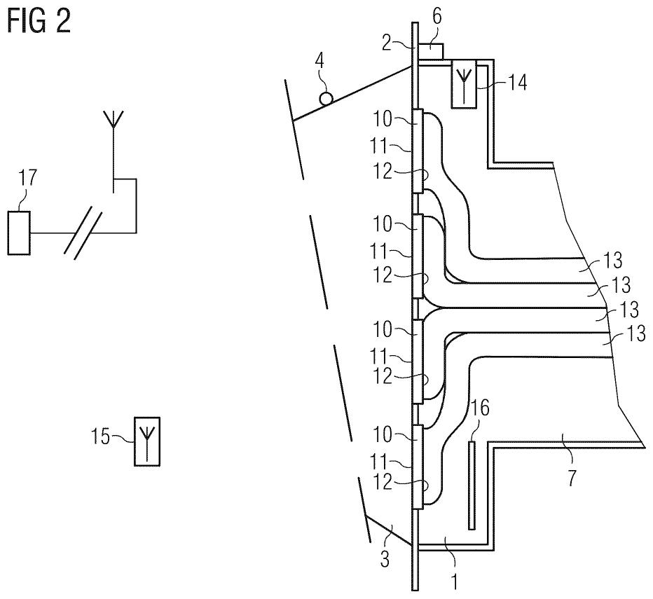

FIG. 2 schematically displays, besides other devices, a part of the main body of the room air conditioner. On the left, indoor heat exchanger 3 has been cut off midway. On the right, arm 7 has been cut off too.

Within housing 1, thermoelectric heat pumps 10 are Peltier elements “CP30338” from the company CUI Devices, arranged in a four-by-four matrix. Their output plates 11 are flush with cover plate 2. Their input plates 12 are connected to heat pipes 13.

A wireless communication module 14 can receive room air temperature data from a separate air temperature sensor 15, which is mounted in the room away from the main body of the room air conditioner and away from the indoor air circulation through the indoor heat exchanger. Using this sensor 15 improves the determination whether a cooling or heating effort must be prolonged. The communication module 14 relays the sensed data to a subordinate controller part 16 in housing 1.

Setting the performance of the thermoelectric heat pumps 10, the subordinate controller part 16 performs closed loop regulation on the basis of room temperature data from the separate air temperature sensor 15 and from the sensor suite 6, on the basis of humidity data from the sensor suite 6 and on the basis of outside temperature data from the air temperature sensor 9. This combination of measurands is used for determining a cooling or heating demand. However, the subordinate controller part 16 amends its output if needed to restrict the temperature difference between the output plates 11 and the input plates 12 to 30° C. Also, it amends its output if needed to restrict condensation on the output plates 11 of the thermoelectric heat pumps 10 or on the indoor heat exchanger 3, which is depicted only in part here. In both cases, it makes the thermoelectric heat pumps 10 cool their output plates 11 less than or not at all even though the sensor output and the setpoint would require doing so. Once in every week, the subordinate controller part 16 amends its output for heating the output plate at 80° C. for 20s.

The setpoint for the closed loop regulation is determined by a superior controller part 17, taking occupant identity into account, if available. The superior controller part 17 is a cloud server on which a dedicated software runs, and which communicates with the subordinate controller part 16 through communication module 14. The superior controller part 17 adjusts the algorithm by which the subordinate controller part 16 calculates the cooling performance of the thermoelectric heat pumps 10 at which in the circumstances condensation would occur. It also analyses the power consumption over time and offers an occupant various control models via an app on his smartphone. It likewise warns an occupant of the weekly heating pulse and suggests airing the room briefly. If the superior controller part 17 determines a need or receives a request for user feedback, it enquires feedback by means of questionnaires that are presented by the app.

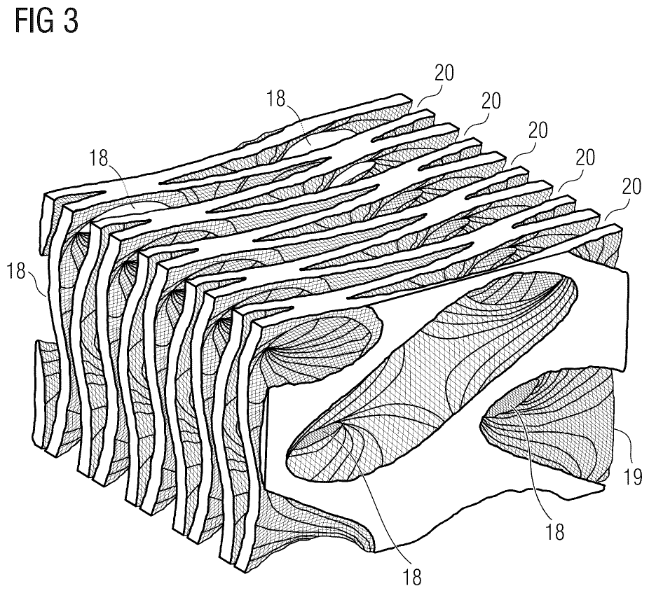

FIG. 3 presents structural detail of the content of indoor heat exchanger 3 of the same or a different room air conditioner, which is uniform everywhere. Thus, the simply connected region with few straight passages in line with the main air flow covers the entire topside of the indoor heat exchanger 3. Its corresponding part, namely the part behind the region, is the entire volume of the heat exchanger 3.

The structure closely resembles a gyroid, the surface of which is curved everywhere. It can be produced by established techniques of added manufacturing. The wall thickness is 140 micrometres. Holes of around 1 mm are recognisably lined up to make four straight passages 18 for the air through the indoor heat exchanger 3. Their direction is in line with the main flow of air from the room towards them, from above in FIG. 1 when the room air conditioner cools the air and from below when it heats the air. Such straight passages contribute 19% to the frontal area of the indoor heat exchanger 3. Flow paths with a straight passage in different directions are interconnected but require approaching air to turn a corner first. Some of these flow paths are blocked at the far end by cover plate 2 or by the flush mounted output plates 11 therein. There, perpendicular straight passages only contribute 3% of the frontal area.

Along the air flow paths of the four straight passages 18, the path wall 19 protrudes and recedes transversally 5 times each within the depicted rectangular volume. Every time, the local reduction of the air flow path cross sectional area is an estimated 80% of the previous air flow path cross sectional area, which covers the large, twisted funnel that leads up to the hole of straight passage 18. Downstream, the estimation of the local increase is around 500%, for the same reason. The largest transversal protrusion is around 0.7 mm, all the way from where the funnel meets up with the funnel of the next parallel straight passage 18 or with the funnel of some side channel 20 that branches off under a different angle. Such interconnected side channels protrude and recede transversally less frequently within the length of the depicted rectangular volume.

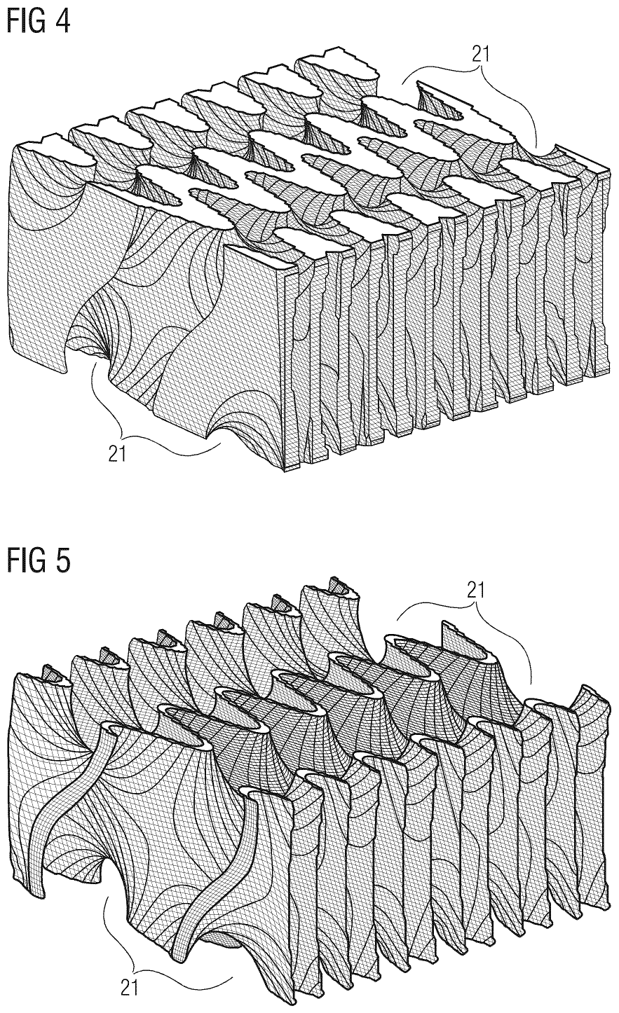

FIG. 4 presents structural detail of the content of a variant indoor heat exchanger, from a different perspective. In this variant, the structure of the indoor heat exchanger is not uniform. It can be produced economically by added manufacturing.

The structure resembles the same gyroid of the same material. However, close to where the indoor heat exchanger is thermally connected to the output plate of the thermoelectric heat pump, the wall thickness is greater, at 180 micrometres. As a result, the local heat conduction within the inside hear exchanger material is improved. Depending on parameters elsewhere, this may allow a straighter shape of the indoor heat exchanger overall yet keep the size of the inner temperature gradient small in dynamic equilibrium.

On top of the depicted rectangular volume, one can spot the onset of holes for two straight passages 21 through the indoor heat exchanger in line with the main flow of air from the room towards them. At the bottom left, the onset of holes of the other two straight passages 21 can be seen. The walls conduct heat from there and from further parts of the indoor heat exchanger towards the thermal connection to the output plate of the thermoelectric heat pump, roughly perpendicular to the four straight passages 21, or conduct heat vice versa.

FIG. 5 shows structural detail of the content of the same variant indoor heat exchanger, but the depicted rectangular volume is now far from where the indoor heat exchanger is thermally connected to the output plate of the thermoelectric heat pump.

Here, the wall thickness is only 50 micrometres. Accordingly, the four straight passages 21 on the top and at the bottom of the depicted rectangular volume are much larger, now contributing no less than 36% to the frontal area of the indoor heat exchanger. Accordingly, a simply connected region can cover such parts of the indoor heat exchanger. For this structure and material however, 36% is near the upper limit, because in practice the heat conduction within the walls of the indoor heat exchanger can just about keep up to avoid overly steep temperature drops in thermodynamic equilibrium. Also, the heat exchange between air and path wall would start to be affected by the reduced disturbance of the air flow.

As can be seen by comparing FIG. 4 and FIG. 5, the ratio of the average cross-sectional area of the indoor heat exchanger to the average cross-sectional area in between its material has decreased with the increased distance from where the indoor heat exchanger is thermally connected to the output plate. This was done by giving the indoor heat exchanger in FIG. 5 thinner material parts. Due to the reduced wall thickness, the local heat conduction capability has deteriorated. For achieving a similar effectivity, the depth of the variant indoor heat exchanger in the direction of the four straight passages 21 must be greater than of the original in FIG. 3. At the same time, the depth close to where the indoor heat exchanger is thermally connected to the output plate of the thermoelectric heat pump can be much smaller. Thanks to optimisation of its wall thickness, the shape of the variant indoor heat exchanger can be straight, like a brick or like half a disk, yet it can remain very large for the given quality of the thermoelectric heat pump and the given area of its output plate.

1. A room air conditioner comprising:
a thermoelectric heat pump including an output plate and an input plate;
an indoor heat exchanger with air flow paths therethrough thermally connected to the output plate and configured in operation to exchange heat with indoor air;
an outdoor heat exchanger thermally connected to the input plate and configured to exchange heat with an outdoor environment;
a sensor to sense a measurand for a cooling or a heating demand;
a controller to generate output based on the sensor output and based on a setpoint to set a performance of the thermoelectric heat pump in accordance with its output;
wherein in a simply connected region on the indoor heat exchanger, straight passages through the indoor heat exchanger in line with the main air flow towards them in operation contribute less than 44% to the frontal area of the region;
the corresponding part of the indoor heat exchanger extends to where a thermal connection to the output plate;
the frontal area of the region is at least half the frontal area of the indoor heat exchanger; and
at least some air flow paths through the indoor heat exchanger do not include such a straight passage.

2. A room air conditioner according to claim 1, wherein straight passages contribute less than 36% to the frontal area of the region.

3. A room air conditioner according to claim 1, wherein along most air flow paths through the indoor heat exchanger the path wall, by protruding or receding transversally, changes the air flow path cross sectional area locally by more than 2% of the previous air flow path cross sectional area at least 20 times.

4. A room air conditioner according to claim 1, wherein the surface of the indoor heat exchanger is uneven over at least 40% of its area.

5. A room air conditioner according to claim 1, wherein the cross-sectional area of the indoor heat exchanger in line with the main air flow towards its leading edges at a shared distance to where it is thermally connected to the output plate gradually decreases with greater distance.

6. A room air conditioner according to claim 1, wherein a shape of the indoor heat exchanger tapers away from a thermal connection to the output plate of the thermoelectric heat pump.

7. A room air conditioner according to claim 1, wherein the indoor heat exchanger comprises a heat isolating surface cover adjacent to a thermal connection to the output plate of the thermoelectric heat pump.

8. A room air conditioner according to claim 1, further comprising an indoor heat exchanger holder to hold the indoor heat exchanger.

9. A room air conditioner according to claim 1, wherein the sensor or the controller includes a module in the main body of the room air conditioner configured to receive data from a remote part of it and to act in accordance therewith.

10. A room air conditioner according to claim 1, wherein the controller is configured at times to amend its output for restricting the temperature difference between the output plate and the input plate of the thermoelectric heat pump.

11. A room air conditioner according to claim 10, wherein the amendment restricts the difference to a maximum below 35° C.

12. A room air conditioner according to claim 1, wherein the controller is configured at times to amend its output for restricting condensation at the output plate of the thermoelectric heat pump or on the indoor heat exchanger.

13. A room air conditioner according to claim 12, wherein the controller is configured to calculate the performance of the thermoelectric heat pump at which condensation would occur.

14. A room air conditioner according to claim 1, wherein the controller is configured at times not to make the thermoelectric heat pump cool the output plate even though the sensor output and the setpoint would require doing so.

15. A room air conditioner according to claim 1, wherein the controller is configured at times to amend its output for heating the output plate temporarily above a minimum that is above 60° C.
